(19) United States
(12) Patent Application Publication
(10) Pub. No.: US 2024/0365877 A1
(43) Pub. Date: Nov. 7, 2024

(54) DRY HEATER DETECTION FOR AEROSOL-GENERATING SYSTEM

(71) Applicant: Philip Morris Products S.A., Neuchatel (CH)

(72) Inventors: Eftychia ANTONIOU, Bristol (GB); Robert William EMMETT, Thame (GB); Benjamin Luke MAZUR, Bristol (GB); Archer Guy Clift ROWBERRY, Gloucestershire (GB)

(73) Assignee: Philip Morris Products S.A., Neuchatel (CH)

(21) Appl. No.: 18/683,296

(22) PCT Filed: Aug. 19, 2022
(86) PCT No.: PCT/EP2022/073178

§ 371 Date: Feb. 13, 2024

(30) Foreign Application Priority Data
Aug. 26, 2021 (EP) 21193374.2

(51) Int. Cl. A24F 40/53; A24F 40/10; A24F 40/51; A24F 40/57

(52) U.S. Cl. CPC A24F 40/53; A24F 40/10; A24F 40/51; A24F 40/57

(57) ABSTRACT

A method of controlling a supply of power to a heating element in an electrically operated aerosol-generating system is provided, the method including: regulating the supply of power to the heating element during discrete heating cycles; determining an electrical resistance ratio of the heating element for a predefined time interval during a heating cycle; calculating a rolling average value of the electrical resistance ratio for n preceding heating cycles, n being an integer greater than 1; comparing the electrical resistance ratio with the calculated rolling average value; determining an adverse condition when the electrical resistance ratio is greater than the calculated rolling average value by more than a threshold value; and controlling power supplied to the heating element based on whether an adverse condition at the heating element is determined, the threshold value for determining an adverse condition being determined from a standard deviation of the electrical resistance ratio.

The present specification relates to a method for operating a heating element in an electrically operated aerosol-generating system. In particular the invention relates to the detection of undesirable heater conditions in an electrically heated aerosol-generating system.

In aerosol-generating systems a liquid aerosol-forming substrate may be delivered from a liquid storage portion to an electrical heating element. Upon heating to a target temperature, the aerosol-generating substrate vaporises to form an aerosol. The liquid substrate may be delivered to the heating element via a capillary component. When the amount of aerosol-generating substrate in the capillary component is depleted, the heating element may enter a so-called dry state. In such dry state the heating element may easily overheat. Overheating of the heating element may affect the aerosol quality. In addition, overheating of the heating element may lead to disruption of the heating element.

Efforts have been made to detect dry state of heating elements used in electrically operated aerosol-generating systems. However, many of these techniques for detecting the depletion of aerosol-generating substrate still require raising the heater temperature substantially, in order to detect a change in the resulting electrical resistance. Moreover, some of these methods require an initial heater resistance to be detected. However, absolute resistance values of heating elements are typically below 1 Ohm and resistance changes of the heating elements entering the dry state may amount to only a few milliohms. Such small changes in absolute resistance values may be difficult to identify in aerosol-generating systems.

It is therefore desirable to provide a method that allows to reliably detect adverse states of a heating element. It would be further desirable to provide a method that allows to reliably detect adverse states of a heating element and that may be used with various types of heating elements. It would be further desirable to provide a method for operating a heating element that prevents operation of the heating element before an adverse state is reached.

According to the present invention there is provided a method of controlling the supply of power to a heating element in an electrically operated aerosol-generating system. The method comprises the steps of regulating the supply of power to the heating element during a plurality of discrete heating cycles, determining an electrical resistance ratio ΔR/Δt of the heating element for a predefined time interval, calculating a rolling average value sₙ of the electrical resistance ratio ΔR/Δt of the heating element for n preceding heating cycles, wherein n is an integer greater than 1. The method further comprises the steps of comparing the electrical resistance ratio ΔR/Δt of the heating element with the calculated rolling average value and determining an adverse condition when the electrical resistance ratio ΔR/Δt is greater than the rolling average value sₙ by more than a threshold value. The power supplied to the heating element is controlled based on whether an adverse condition at the heating element is determined.

For a given power supply to the heating element, the maximum temperature at the heating element is limited by the amount of available aerosol-forming substrate. This is because of the latent heat of vaporisation of the aerosol-forming substrate. Therefore the maximum electrical resistance at the heating element may be related to the amount of aerosol-forming substrate available at the heating element. For example, a lack of aerosol-forming substrate may result in a significant rise in maximum electrical resistance as detected over a plurality of successive heating cycles. Therefore empty cartridges may be detected if an increase in maximum electrical resistance from one puff to the next exceeds a threshold value.

However, the supply of aerosol-forming substrate at the heating element may gradually reduce over the lifetime of a cartridge. As the aerosol-forming substrate starts to deplete the maximum resistance of the heating element may also progressively increase over successive puffs. Therefore during an adverse condition there may be no substantial difference in the maximum resistance detected between two successive puffs. This means an empty cartridge may not be quickly detectable.

In a dry state a heating element may reach more than 1000 degrees Celsius. This typically leads to permanent disruption of the heating element such as filament breakage for mesh heaters or instant breaking of ceramic heaters. Apart from disruption of the heating elements undesirable aerosol components may be formed.

A dry wick state can be caused by a depleted cartridge, such that not sufficient liquid is available that could be transported to the heating element. A dry wick state may also be caused by other circumstances. A dry wick state can result from a misplacement of the aerosol-generating device, due to which a supply of liquid substrate is stopped or slowed down. A dry wick may also be caused by excessive drawing of the user. Independent from the cause of the dry wick state, operation of the heating element in a dry wick state should be prevented. Thus, the present invention is configured to warn the user, of occurrence of a potential dry wick state. If the dry wick state is caused by a depletion of the cartridge, operation should usually only be resumed after replacement or refilling of the cartridge. For other causes, such as misplacement of the aerosol-generating device, operation may be resumed after a temporary locking of the aerosol-generating device.

The correlation between temperature and resistance of heating elements can be expressed by the following equation:

$$\\ \begin{matrix}Temperature = \frac{{R}_{measured} - {R}_{nom heater}}{{R}_{nom heater} \times α} + {T}_{ambient} & ( 1 )\end{matrix}$$

The nominal resistance and the alpha value a depend on the type of heating element used. The nominal resistance of typically used heating elements may be very low, and may be below 1 Ohm.

The alpha value for a mesh heater may be about 0.00119 and its nominal resistance may amount to 0.58 Ohm. The alpha value for a ceramic heater may be about 0.00016 and its nominal resistance may amount to about 0.98 Ohm. The alpha value for a wick & coil heater may be about 0.00013 and its nominal resistance may amount to about 1.6 Ohm.

While all heating elements show a rise in electrical resistance when entering the dry wick state, the absolute increase in electrical resistance may be very small and may only amount to about 0.006 Ohm. Thus, a detection of dry wick states based on absolute resistance changes may be hampered by poor electrical connections. Such poor electrical connections may lead to similar or even higher changes in the overall resistance and may cause false triggers to unnecessarily lock the system.

It has been surprisingly found that a reliable detection of a dry wick state can be carried out by monitoring the electrical resistance ratio ΔR/Δt of a heating element for a predefined time interval.

In more detail it was found that the electrical resistance ratio ΔR/Δt of a given heating element shows a characteristic increase just before or upon entry into the dry wick state. Since the changes in the electrical resistance ratio ΔR/Δt of a given heating element may be very small, statistical methods are needed to identify statistically significant changes in the electrical resistance ratio ΔR/Δt. One advantage of the proposed method lies in the fact that a current parameter of a given heating element is repeatedly determined and compared to previous values of this parameter. Thus, the heating elements performance is continuously compared with its previous performance. Thus the system is continuously compared with itself. This allows to reliably determine whether the heating element starts to leave the desired range of operation. Manufacturing differences between constructional identically heating elements are thus effectively compensated.

It has been identified that the following equation is useful to determine whether a given heating element is about to enter or has entered the dry wick state:

$$\\ \begin{matrix}\frac{Δ R}{Δ t} - {s}_{n} > A σ & ( 2 )\end{matrix}$$

In this equation ΔR/Δt is the electrical resistance ratio, sₙ is the rolling average of the previous n values of the electrical resistance ratio, σ is a standard deviation calculated on the basis of a number of previous values of the electrical resistance ratio, and A is a numerical value that is to be empirically determined for each type of heating element.

The standard deviation σ is calculated on the basis of a limited number of previous values of the electrical resistance ratio. Accordingly, this value is actually not a true statistical measure of the standard deviation (A true standard deviation can only be determined at the end of a heating cycle taking into account all measured values). The standard deviation σ may be also described as mean value for calculating each sample's weighting. This mean value is rather a rolling average of a certain length and not the true sample mean. With respect to the present invention, the deviation σ may be seen as an exponentially weighted standard deviation (EWMSD). At the beginning of the sampling period, the weight of each sample decays exponentially. This is specifically helpful in heating aerosol-forming substrate, since it has been detected that at the start of the heating process, the heating process is not yet uniform and the individual deviations are rather high.

One of the purposes of using this mean value is to minimise data usage and compute time. Although accuracy and statistical validity are reduced by this method, the overall performance is increased. Since a reduced number of values have to be calculated, the monitoring program can run for extended time periods at a high sampling speed.

As can be seen from equation (2) the method of the present invention includes determining a statistical measure of a standard deviation σ of the electrical resistance ratio. This statistical value is referred to as a in equation (2).

In addition, the rolling average sₙ of the previous n values is determined. With equation (2) a statistically significant increase of the electrical resistance ratio ΔR/Δt is detected, by comparing a new value of the electrical resistance ratio, with the rolling average sₙ of the previous n values for the electrical resistance ratio.

If this difference is higher than the product of the calculated standard deviation σ and an empirically determined and predefined constant value A, a statistically significant increase is determined. In such case the system is configured to take specific actions to further ensure safe operation. The system may either be triggered to enter a lock-out mode and prevent the system from continuing the user experience. Alternatively, the system may be triggered to re-check, in order to confirm that the system is entering a dry stage.

The step of re-confirmation is useful to prevent that a single spike value unduly prevents operation of the system. However, if the statistical increase of the electrical resistance ratio is reconfirmed, the system may then enter the lock-out mode, in which further operation is prevented. Operation may then only be resumed, if the cause for the lock-out is resolved. Typically, the user will have to re-fill or replace a consumed cartridge.

The present invention may generally be used with any sort of heating elements in which a liquid aerosol forming substrate is heated. The heating elements may include a mesh heater, a wick & coil heater or a ceramic heater.

Wick & coil heaters are readily known in the prior art and essentially comprise a porous element that is in contact with a liquid storage portion. The liquid aerosol-forming substrate is transferred via capillary action towards a portion of the porous element around which a heating coil is wound. In operation the heat generated by the heating coil is used to vaporize the liquid and to eventually form an aerosol.

For wick & coil heaters the resistance increases steadily throughout the heating cycle, but rises rapidly once the heating element enters dry state.

A mesh heater may be an array of filaments, for example arranged parallel to each other. The mesh may be woven or non-woven. The mesh may be formed using different types of weave or lattice structures. Alternatively, the electrically conductive heating element consists of an array of filaments or a fabric of filaments. The mesh, array or fabric of electrically conductive filaments may also be characterized by its ability to retain liquid.

The filaments of the heating element may be formed from any material with suitable electrical properties. Suitable materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum and metals from the platinum group.

The electrical resistance of the mesh, array or fabric of electrically conductive filaments of the heating element may be between 0.3 Ohms and 4 Ohms. Preferably, the electrical resistance is equal or greater than 0.5 Ohms. More preferably, the electrical resistance of the mesh, array or fabric of electrically conductive filaments is between 0.6 Ohms and 0.8 Ohms, and most preferably about 0.68 Ohms.

It has been found that for mesh heaters the maximum resistance is very consistent between puffs in the wet state of the heating element and rises rapidly in the dry state.

A ceramic heater may comprise a suitable ceramic material. The ceramic material may be porous ceramic material. The capillary material may have any suitable capillarity and porosity so as to be used with different liquid physical properties. The capillary material may be configured to convey the aerosol-forming substrate from a liquid storage portion.

The ceramic heater may comprise a resistive material forming the heating portion of the heating element. The resistive material may include: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum platinum, gold and silver

For ceramic heaters the resistance increases for a few puffs when the ceramic heating element starts to become dry. The resistance then decreases, but increases again significantly when the resistive heater portion starts deforming.

The method of the present invention was successfully used to detect dry wick states at the beginning or end of the first dry puff for conventional, mesh heaters, wick & coil heaters and ceramic heaters. Thus, the method can be used for early detecting of the system to enter dry stage.

Power may be supplied to the heating element continuously following activation of the system or may be supplied intermittently, such as on a puff-by-puff basis. The power may be supplied to the heating element in a pulsed mode.

In a pulsed mode electrical power may be supplied to the heating element in the form of pulses of electrical current. The electric circuitry may be configured to monitor the electrical resistance of the heating element, and preferably to control the supply of power to the heating element dependent on the electrical resistance of the heating element.

The number of pulses during a heating cycle may be chosen as suitable for a given device. The number of pulses may amount to between 1 and 50 pulses per heating cycle. The number of pulses may amount to between 5 and 30 pulses per heating cycle. The number of pulses may amount to between 10 and 20 pulses per heating cycle.

In pulsed mode, the heating elements may be operated in fixed power (FP) mode or in fixed duty cycle (FDC). It has been identified that fixed power mode is best suited to be used with the present invention.

As used herein, the term “duty cycle” refers to the amount of time a signal is on and to the amount of time the signal is off. The duty cycle is given in percent. For example, a duty cycle of 60% means that the signal is on 60% of the time and that the signal is off 40% of time.

For determining the rolling average sₙ of the electrical resistance ratio preferably less values are taken into account than for determining the standard deviation σ. The rolling average sₙ may be determined taking into account the previous n values of the electrical resistance ratio ΔR/Δt, wherein n ranges between 1 and 30. The rolling average sₙ may be determined taking into account the previous n values of the electrical resistance ratio ΔR/Δt, wherein n ranges between 5 and 20. The rolling average sₙ may be determined taking into account the previous 10 values of the electrical resistance ratio ΔR/Δt. This value may be referred to as s₁₀. By taking into account only a limited number of values of the electrical resistance ratio, computing power can be saved, while at the same time sufficient precision of the dry wick identification is maintained.

The threshold value for determining an adverse condition may be determined from a standard deviation σ of the electrical resistance ratio ΔR/Δt. The standard deviation σ of the electrical resistance ratio ΔR/Δt may be determined as rolling average of the resistance ratio ΔR/Δt taking into account the previous m values of the electrical resistance ratio ΔR/Δt, wherein m may be any predetermined number. M may amount to 50, 30, or 10. The number of values considered for determining the standard deviation σ may depend on the available computing power. The number m of values used for determining the standard deviation σ may be larger than the number n of values used for determining the rolling average sₙ.

The threshold value for determining an adverse condition may be determined from a product of the standard deviation σ of the electrical resistance ratio ΔR/Δt and a constant value. The constant value A may be identified empirically for each type of heating element used. Constant value A may be used to adjust sensitivity of the detection method.

The smaller the constant value A, the lower the threshold and the more sensitive is the dry wick detection. However, reliability may suffer from using too low constant values A, since an increased sensitivity may cause false triggers and premature lockouts. On the other hand, too high constant values A may result in late detection of dry wick state or may even prevent detection at all.

The optimum constant value A is preferably determined for each type of heating element used.

For mesh heaters the constant value A may range between 1.5 and 3. For mesh heaters the constant value A may amount to about 2.5.

For ceramic heaters the constant value A may range between 0.5 and 2.5. For ceramic heaters the constant value A may amount to about 1.25.

For wick & coil heaters the constant value A may range between 0.5 and 3. For wick & coil heaters the constant value A may amount to about 1.0 or to about 1.5.

The controller of the aerosol-generating system may be configured to transfer the aerosol-generating system into a locked state, if an adverse condition is determined. The adverse condition may be the detection of the heating element having entered or being about to enter the dry wick state. In a dry wick state, aerosol formation may lead to undesirable aerosol components. Excess heating in a dry wick state may also lead to disruption of the heating element. In the locked state operation of the heating element may be prevented.

The controller of the aerosol-generating system may be configured to transfer the aerosol-generating system into a locked state in a one-step trigger process. In this case, the aerosol-generating system is transferred into the locked state when the condition as defined in equation (2) is fulfilled. Thus, when a statistically significant increase in the electrical resistance ratio ΔR/Δt occurs, and the deviation of the electrical resistance ratio ΔR/Δt from the rolling average sₙ exceeds the threshold Aσ, the aerosol-generating system is transferred into the locked state. In the locked state operation of the heating element is prevented until the user replaces or re-fills the cartridge.

The controller of the aerosol-generating system may be configured to transfer the aerosol-generating system into a locked state in a two-step trigger process. In this case, the aerosol-generating system is transferred into a temporary locked state once the first trigger condition (also referred herein as “dry state” condition) as defined in equation (2) is fulfilled. When a dry state condition is detected, operation of the aerosol-generating system may only be locked temporarily to allow the heating element to cool down. After this temporary lockout, the aerosol-generating system is configured to resume operation. If within the next heating pulse again a statistically significant increase is detected and equation (2) is again fulfilled, the aerosol-generating system is transferred into a permanent locked state. If however, within the next heating pulse no statistically significant increase is detected and equation (2) is not fulfilled, the aerosol-generating system is considered to have returned into a wet state. In the wet state normal operation of the aerosol-generating system is allowed.

A two-step trigger process may be more reliable, since false positive detection of a dry state is less likely. A single false positive detection, does not lead to a locking of the aerosol-generating system. A permanent locking of the system occurs only when a dry state detection is confirmed in the subsequent heating cycle.

As discussed above, sensitivity of the method can be adjusted by the choice of the constant value A in equation (2). In a two-step trigger process this parameter may be different for the first trigger step and for the second trigger step. In particular in a two-step trigger process the constant value may be increased in the second trigger step. By increasing the constant value A in the second trigger step, the threshold for detecting a dry state is increased and the probability of a second false positive result is decreased.

In addition or in the alternative, in a two-step trigger process the constant value A in the first trigger step may also be deliberately decreased, with the result that for the first trigger step the sensitivity is increased. This higher sensitivity may be advantageous, since in this way the chance to timely detect a dry wick is increased. However, by increasing the sensitivity a higher number of false positives may be obtained in the first trigger step. In such case, a higher constant value A may be useful to effectively identify these false positives and only enter into a permanent lockout, when also the dry wick condition of the second step is fulfilled.

The time period for temporary lockout in a two-step process may be adjusted as deemed suitable. Even during a rather short time period of only a few seconds a significant cooling down of the heating element may be achieved. The time period of the temporary lockout may be chosen as deemed suitable. The time period of the temporary lockout may be chosen depending on the internal design of the device or depending on user preferences. The time period of the temporary lockout may range between 0.01 and 10 seconds. The time period of the temporary lockout may range between 0.1 and 5 seconds. The time period of the temporary lockout may range between 1 and 3 seconds.

The electrical resistance ratio ΔR/Δt may be determined from the maximum resistance value determined in the first two heating pulses of a heating cycle. In this case ΔR may be the difference in maximum resistance between the first and the second heating pulse of a heating cycle. The value of Δt is the pulse width between the two first heating pulses of this heating cycle.

It has been found that for some heating elements a dry puff condition may already be identified by the electrical resistance ratio ΔR/Δt at the beginning of a puff. Determining a dry puff condition at the beginning of a puff works particularly reliable when a heating element in the form of a mesh heater is used. Detecting a dry puff at the beginning of the heating cycle, may allow to identify a dry puff, before the dry puff has actually been performed. Thus, the system may be stopped before a dry puff condition occurs. This may help to prevent inhalation of undesirable aerosol components and may help to prevent potential damage to the heating element.

The electrical resistance ratio ΔR/Δt may be determined from the difference of the maximum resistance values determined for two consecutive heating cycles. In this case ΔR may also be referred to as ΔRₘₐₓ. The value of Δt is the length of a heating cycle. This method was found to work reliable with ceramic heating elements. During a typical heating cycle, the maximum temperature and the maximum resistance occurs at the end of the heating cycle. Accordingly, this detection is carried out at the end of a puff and at the end of the corresponding heating cycle. The system may be stopped directly after a dry puff condition occurs. This may also help to prevent inhalation of undesirable aerosol components and may help to prevent potential damage to the heating element.

The electrical resistance ratio ΔR/Δt may be determined from the difference of the increase in resistance during a heating cycle determined for two consecutive heating cycles. The increase in resistance during a heating cycle is the difference between the minimum resistance value and the maximum resistance value determined for a given heating cycle. Typically this increase is the difference of the resistance values determined in the first and the last heating pulse. Thus, for each heating cycle the increase in the range of the resistance value is determined. A significant increase of the range of the resistance value is an indication of an occurrence of a dry wick condition. In this case ΔR may also be referred to as ΔR_{RANGE}. The value of Δt is the length of a heating cycle. This method was found to work reliable with wick & coil heating elements. Since again, during a typical heating cycle, the maximum temperature and the maximum resistance occurs at the end of the heating cycle, the resistance range is determined at the end of each heating cycle. Accordingly, this detection is carried out at the end of a puff and at the end of the corresponding heating cycle. The system may be stopped directly after a dry puff condition occurs. This may also help to prevent inhalation of undesirable aerosol components and may help to prevent potential damage to the heating element.

The suitable moment to collect resistance data for determining whether a dry wick situation has occurred or is about to occur, may depend on the relative dimensions of the heating element and the wicking element.

In a mesh heating element, the wicking element may be rather small compared to the size of the heating element. Accordingly a strong increase may be seen at the beginning of a heating cycle. Thus, evaluation of resistance readings at the beginning of a heating cycle is characteristic for the subject heating process. Such evaluation allows to very early detect a dry puff.

In a ceramic heating element, the wicking element may be large compared to the size of the heating element. Accordingly a rather slow response is seen at the beginning of a heating cycle. Thus, evaluation of resistance readings at the end of a heating cycle is more reliable to characterize a heating process. Thus, in this case it may be advantageous to use ΔRₘₐₓ in order to identify a dry wick state.

In a wick & coil heating element, the wicking element may have about the same size as the heating element. In this case it is preferable to evaluate the resistance readings at the beginning and at the end of a heating cycle. Therefore the change in the range of the heater temperature throughout the heating cycle is a suitable parameter for the electric resistance ratio. Thus, in this case it may be advantageous to use ΔR_{RANGE} in order to identify a dry wick state.

When plotting the detected resistance of the heater versus time in a 2D plot, a normal resistance curve generally may have a large gradient, i.e. increases more quickly at the start as the temperature increases up to the liquid boiling point, but as it approaches the boiling point more energy is needed to heat the liquid and both temperature and resistance ratio decrease. The shape of such normal resistance curve may look like a curved “F” being defined by two legs defining an angle θ there between. The angle θ between the two legs and the distance between the first and last resistance reading are very consistent in a wet state of the wick. When the wick becomes dry, the electrical resistance ratio ΔR/Δt increases, resulting in a higher end resistance. The angle θ and the distance between the first and last resistance reading increase in the dry wick region.

The electrical resistance ratio ΔR/Δt may be determined from the angle θ defined by the two legs of a normal electrical resistance curve. The first leg may be approximated by a vertical line through the first point of the electrical resistance curve. The second leg may be defined as a linear average of the electrical resistance readings, defining the second leg.

The value of angle θ may be considered as a measure of the electrical resistance ratio ΔR/Δt and may be used in equation (2) for determining whether a dry wick condition has occurred. This method was found to work reliable with mesh heating elements. Since again, during a typical heating cycle, the maximum temperature and the maximum resistance occurs at the end of the heating cycle, the resistance range is determined at the end of each heating cycle. Accordingly, this detection is carried out at the end of a puff and at the end of the corresponding heating cycle. The system may be stopped directly after a dry puff condition occurs. This may also help to prevent inhalation of undesirable aerosol components and may help to prevent potential damage to the heating element.

The angle θ may be calculated from the slopes of the two legs of the electrical resistance curve. For this purpose, the two legs may be approximated by straight lines. The angle θ is then the angle defined between these straight lines. The slopes may be determined by any suitable method known to the skilled person. The slopes may be determined by taking into account the first and last data points of a given heating cycle. The slopes may be determined by taking into account the curvature k(t) of the electrical resistance curve. Exemplary methods for determining the angle θ are described in more detail further below. Which of these methods is the most appropriate method, may depend on the accuracy needed and the noisiness of the electrical resistance data.

The aerosol-generating system may comprise electric circuitry. The electric circuitry may comprise a microprocessor, which may be a programmable microprocessor. The microprocessor may be part of a controller. The electric circuitry may comprise further electronic components. The electric circuitry may be configured to regulate a supply of power to the heating element.

As used herein, an ‘electrically operated aerosol-generating system’ means a system that generates an aerosol from one or more aerosol-forming substrates. An aerosol-generating system may comprise an aerosol-generating device and an aerosol-generating article or a cartridge. The aerosol-generating article may comprise an aerosol-forming substrate. The aerosol-forming substrate may be contained in a cartridge.

As used herein, the term ‘aerosol-forming substrate’ means a substrate capable of releasing volatile compounds that may form an aerosol. Such volatile compounds may be released by heating the aerosol-forming substrate.

An advantage of providing a cartridge is that the aerosol-forming substrate is protected from ambient environment. In some embodiments, ambient light cannot enter the cartridge as well, so that the light-induced degradation of the aerosol-forming substrate may be avoided. Moreover, a high level of hygiene can be maintained.

The aerosol-forming substrate may be contained in a refillable liquid storage portion in the aerosol-generating device. The aerosol-forming substrate may be contained in a refillable cartridge in the aerosol-generating system. Preferably the aerosol-forming substrate is contained a disposable cartridge in the aerosol-generating system. Said cartridge may be replaced after a single session of use, or it may be replaced after a plurality of sessions of use. This may allow the user to replace a depleted cartridge in a safe and efficient manner.

The aerosol-forming substrate may be in a liquid phase at room temperature. As used herein, the terms “liquid” and “solid” refer to a state of the aerosol-forming substrate at room temperature. The aerosol-forming substrate may be a flowable liquid at room temperature. For a liquid aerosol-forming substrate, certain physical properties, for example the vapour pressure or viscosity of the substrate, are chosen to be suitable for use in the aerosol generating system.

The aerosol-forming substrate may comprise plant-based material. The aerosol-forming substrate may comprise tobacco. The aerosol-forming substrate may comprise a tobacco containing material containing volatile tobacco flavour compounds, which are released from the aerosol-forming substrate upon heating. The aerosol-forming substrate may alternatively comprise a non-tobacco-containing material. The aerosol-forming substrate may comprise homogenised plant-based material. The aerosol-forming substrate may comprise homogenised tobacco material. The aerosol-forming substrate may comprise at least one aerosol-former. An aerosol-former may be any suitable known compound or mixture of compounds that, in use, facilitates formation of a dense and stable aerosol and that is substantially resistant to thermal degradation at the operating temperature of operation of the system. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Preferred aerosol formers are polyhydric alcohols or mixtures thereof, such as triethylene glycol, 1,3-butanediol and, most preferred, glycerine. The aerosol-forming substrate may comprise other additives and ingredients, such as flavourants.

For the liquid aerosol-forming substrate, certain physical properties, for example the vapour pressure or viscosity of the substrate, are chosen in a way to be suitable for use in the aerosol generating system. The liquid preferably comprises a tobacco-containing material comprising volatile tobacco flavour compounds which are released from the liquid upon heating. Alternatively, or in addition, the liquid may comprise a non-tobacco material. The liquid may include water, ethanol, or other solvents, plant extracts, nicotine solutions, and natural or artificial flavours. Preferably, the liquid further comprises an aerosol former. Examples of suitable aerosol formers are glycerine and propylene glycol.

An electrical aerosol-generating system may include additional components, such as a charging unit for recharging an on-board electric power supply in an electrically operated aerosol-generating device.

The aerosol generating system may comprise a housing. The housing may comprise any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK) and polyethylene. Preferably, the material is light and non-brittle.

The power supply may be any suitable power supply, for example a DC voltage source such as a battery. The power supply may be a Lithium-ion battery, a Nickel-metal hydride battery, a Nickel cadmium battery, or a Lithium based battery, for example a Lithium-Cobalt, a Lithium-Iron-Phosphate, Lithium Titanate or a Lithium-Polymer battery.

The power supply may include a rechargeable Lithium-ion battery. The electrical power supply may comprise another form of charge storage device such as a capacitor. The electrical power supply may require recharging. The electrical power supply may have a capacity that allows for the storage of enough energy for one or more uses of the aerosol-generating device. For example, the electrical power supply may have sufficient capacity to allow for the continuous generation of aerosol for a period of around six minutes, corresponding to the typical time taken to smoke a conventional cigarette, or for a period that is a multiple of six minutes. In another example, the electrical power supply may have sufficient capacity to allow for a predetermined number of puffs or discrete activations.

The electric circuitry may be configured to commence a supply of electrical power from the electrical power supply to the heating element at the start of a heating cycle. The electric circuitry may be configured to terminate a supply of electrical power from the electrical power supply to the heating element at the end of a heating cycle.

The electric circuitry may be configured to provide a continuous supply of electrical power from the electrical power supply to the heating element.

The electric circuitry may be configured to provide an intermittent supply of electrical power from the electrical power supply to the heating element. The electric circuitry may be configured to provide a pulsed supply of electrical power from the electrical power supply to the heating element.

A pulsed supply of electrical power to the heating element may facilitate control of the total output from the heating element during a time period. Advantageously, controlling a total output from the heating element during a time period may facilitate control of temperature.

The electric circuitry may be configured to vary the supply of electrical power from the electrical power supply to the heating element. The electric circuitry may be configured to vary a duty cycle of the pulsed supply of electrical power. The electric circuitry may be configured to vary at least one of a pulse width and a period of the duty cycle.

The present invention also relates to an electrically operated aerosol-generating system comprising a heating element for heating an aerosol-forming substrate proximate to the heating element, a power supply for supplying power to the heating element, and electric circuitry configured to regulate the supply of power to the heating element during a plurality of discrete heating cycles. The electric circuitry is configured to determine an electrical resistance ratio ΔR/Δt of the heating element for a predefined time interval, to calculate a rolling average value of the electrical resistance ratio ΔR/Δt of the heating element for n preceding heating cycles, wherein n is an integer greater than 1 and to compare the electrical resistance ratio ΔR/Δt of the heating element with the calculated rolling average value. The electric circuitry is further configured to determine an adverse condition when the electrical resistance ratio ΔR/Δt is greater than that the rolling average value by more than a threshold value and to control power supplied to the heating element based on whether an adverse condition at the heating element is determined.

The aerosol generating system may be portable. The aerosol generating system may have a size comparable to a conventional cigar or cigarette. The smoking system may have a total length between approximately 30 mm and approximately 150 mm. The smoking system may have an external diameter between approximately 5 mm and approximately 30 mm.

The aerosol-generating system may comprise a user input device. The user input device may comprise at least one of a push-button, a scroll-wheel, a touch-button, a touch-screen, and a microphone. The user input device may allow a user to control one or more aspects of the operation of the aerosol-generating system. The user input device may allow a user to activate a supply of electrical power to the heating element, to deactivate a supply of electrical power to the heating element, or both.

Features described in relation to one embodiment may equally be applied to other embodiments of the invention.

The invention will be further described, by way of example only, with reference to the accompanying drawings in which:

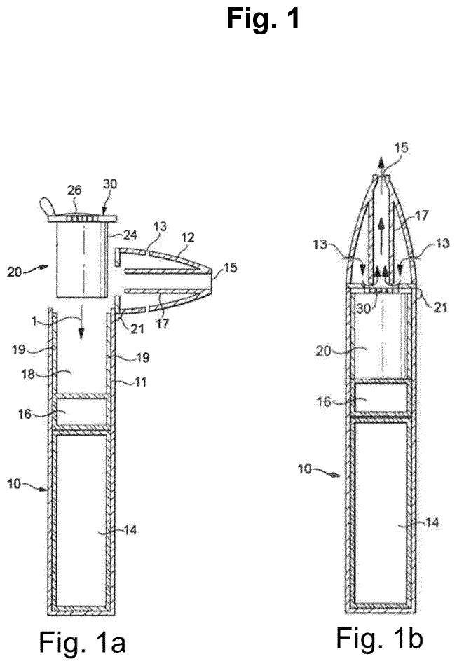

FIG. 1 shows a prior art aerosol-generating system usable with the present invention;

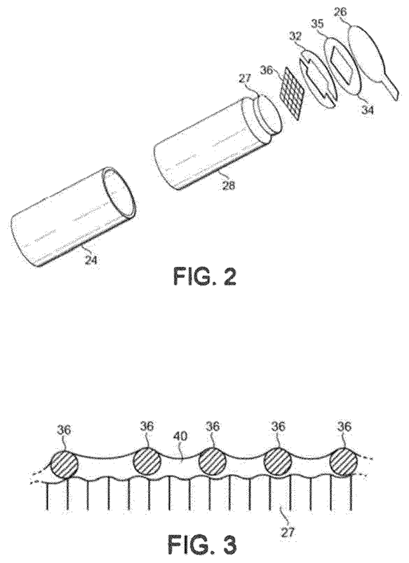

FIG. 2 shows details of the cartridge of the aerosol-generating system of FIG. 1;

FIG. 3 shows details of a mesh heating element;

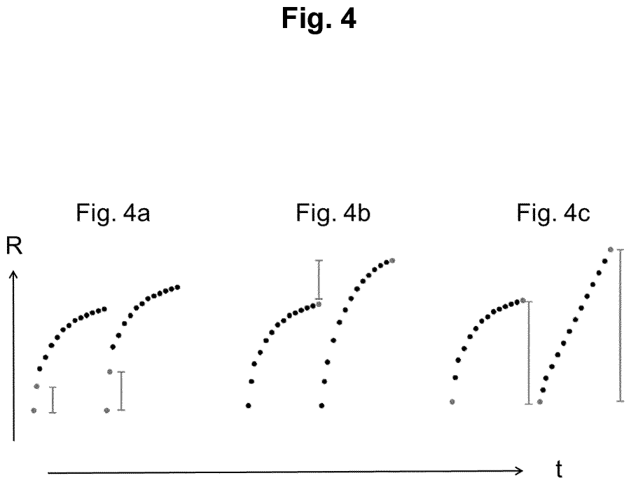

FIG. 4 is a plot showing the change in electrical resistance of various heating elements during heating cycles;

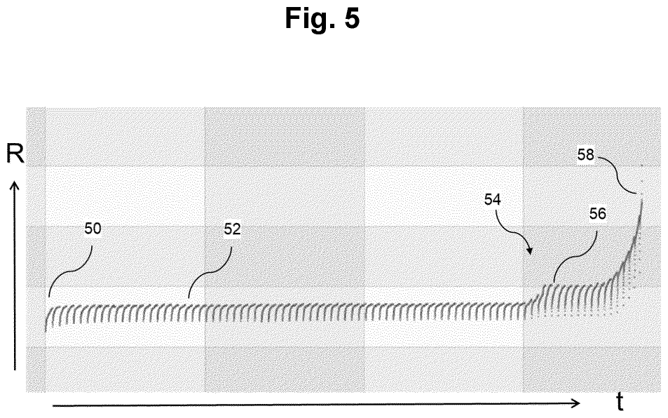

FIG. 5 is a plot showing the change in electrical resistance during a lifetime of a mesh heating element;

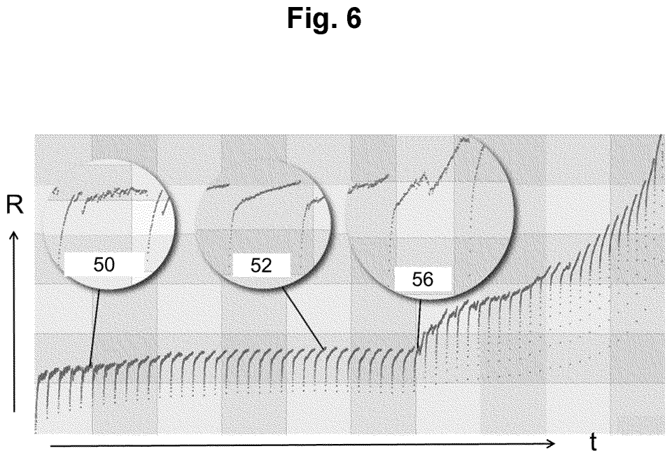

FIG. 6 is a plot showing the change in electrical resistance at transition into the dry state;

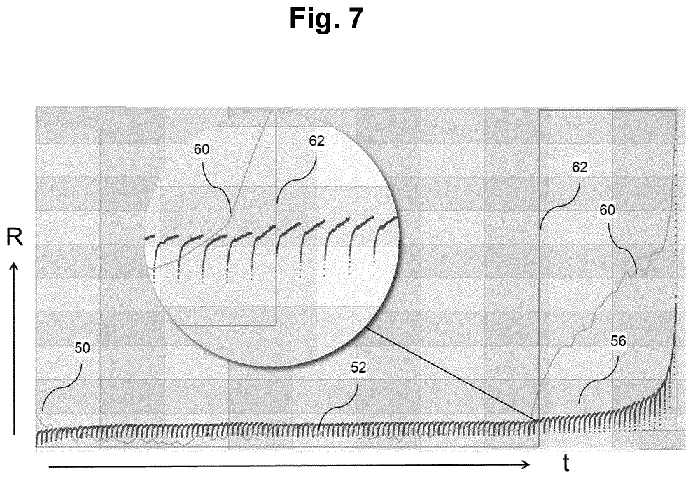

FIG. 7 is a plot showing the change in electrical resistance ratio for a mesh heater;

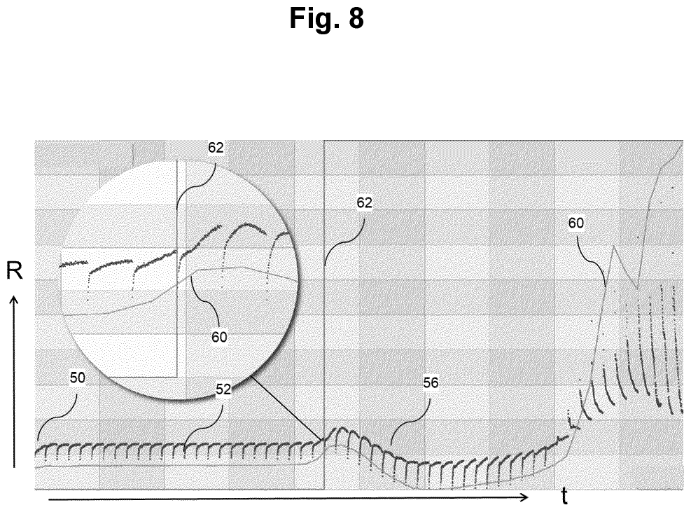

FIG. 8 is a plot showing the change in electrical resistance ratio for a ceramic heater;

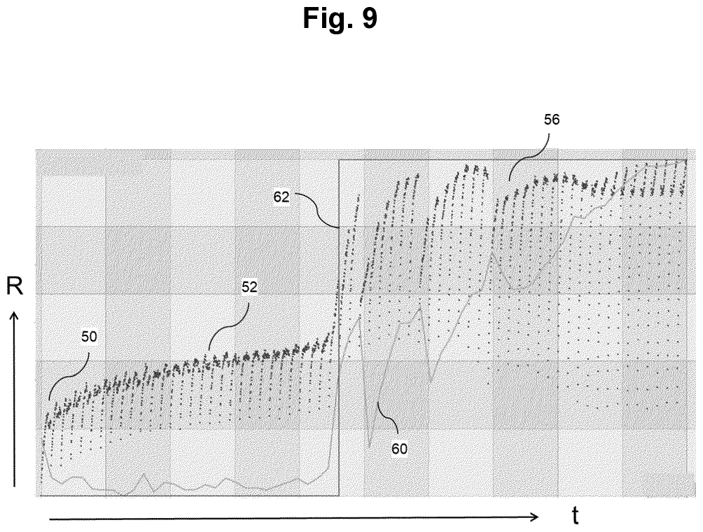

FIG. 9 is a plot showing the change in electrical resistance ratio for a wick & coil heater;

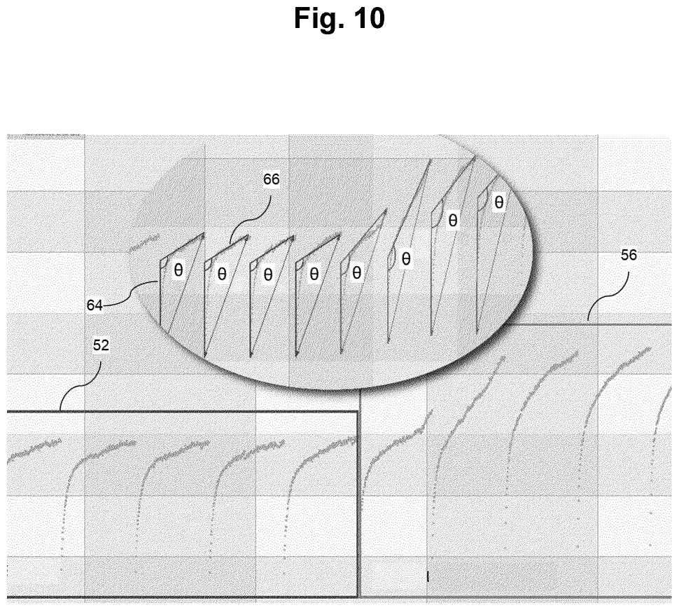

FIG. 10 is a plot showing the change of angle θ for a mesh heater;

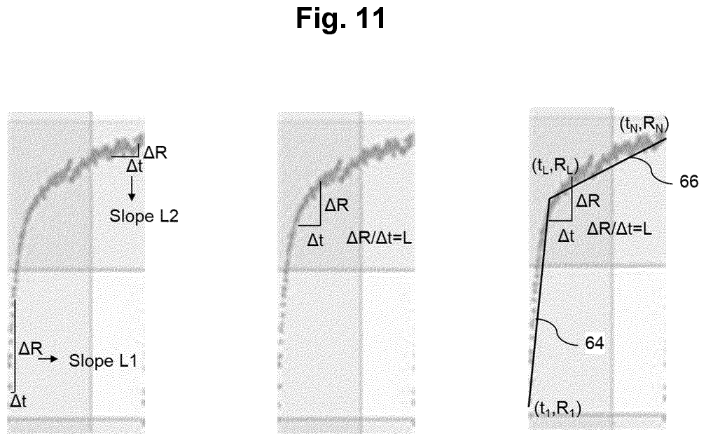

FIG. 11 illustrates a method of determining the angle θ;

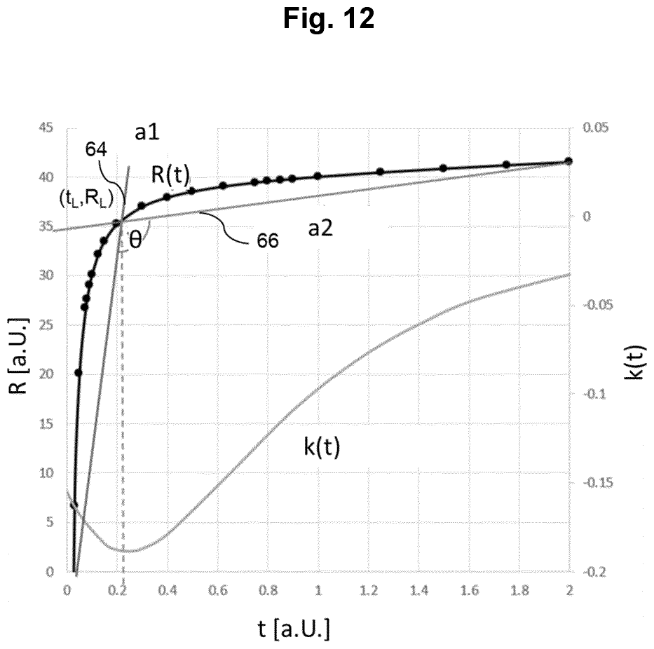

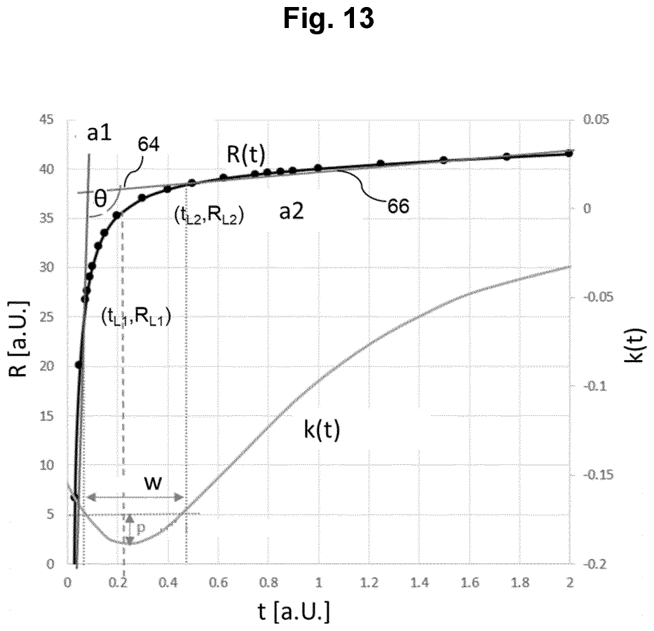

FIG. 12 illustrates a method of determining the angle θ by using the curvature k(x) of the electrical resistance curve;

FIG. 13 illustrates a modification of the method of FIG. 12; and

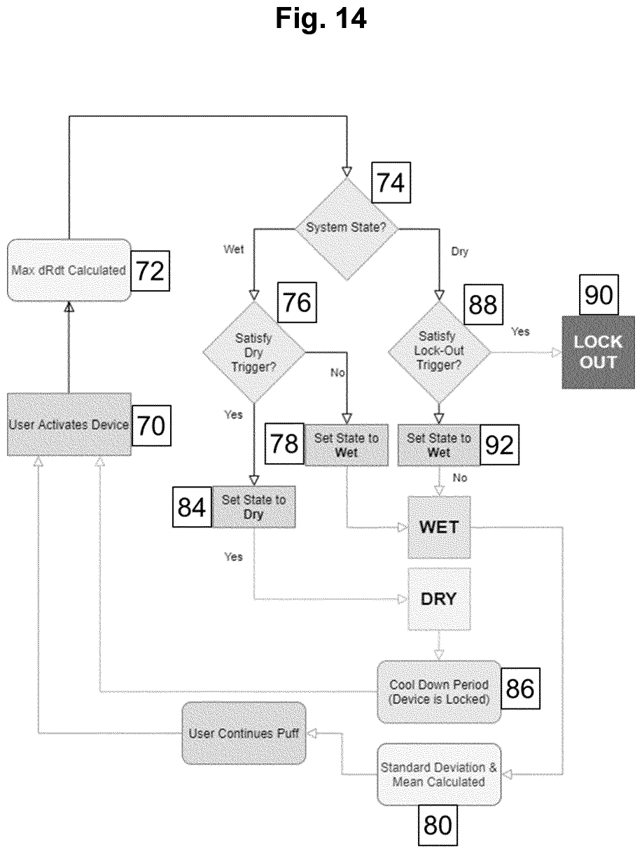

FIG. 14 is a diagram showing the steps of a two-trigger method.

FIGS. 1a and 1b are schematic illustrations of a known electrically heated aerosol-generating system that may be used in accordance with the method of the invention. The aerosol-generating system comprises an aerosol-generating device 10 and a cartridge 20.

The cartridge 20 contains an aerosol-forming substrate in a cartridge housing 24 and is configured to be received in a cavity 18 within the device. The cartridge 20 is a disposable cartridge. A user may replace the cartridge 20 once the aerosol-forming substrate in the cartridge is depleted. FIG. 1a shows the cartridge 20 just before insertion into the device 10, with the arrow 1 in FIG. 1a indicating the direction of insertion of the cartridge 10.

The aerosol-generating device 10 is portable and has a size comparable to a conventional cigar or cigarette. The device 10 comprises a main body 11 and a mouthpiece portion 12. The main body 11 contains a battery 14, such as a LithiumIron-Phosphate battery, electric circuitry 16 and a cavity 18. The cavity 18 has a circular cross-section and is sized to receive a housing 24 of the cartridge 20.

The electric circuitry 16 comprises a programmable microprocessor. The mouthpiece portion 12 is connected to the main body 11 by a hinged connection 21 and can move between an open position as shown in FIG. 1a and a closed position as shown in FIG. 1b. The mouthpiece portion 12 is placed in the open position to allow for insertion and removal of cartridges 20 and is placed in the closed position when the system is to be used to generate aerosol. The mouthpiece portion comprises a plurality of air inlets 13 and an outlet 15. In use, a user sucks or puffs on the outlet to draw air from the air inlets 13, through the mouthpiece portion to the outlet 15, and thereafter into the mouth or lungs of the user. Internal baffles 17 are provided to force the air flowing through the mouthpiece portion 12 past the cartridge.

FIG. 1b shows the system of FIG. 1a with the mouthpiece portion 12 in the closed position. The mouthpiece portion 12 is retained in the closed position by a clasp mechanism. The mouthpiece portion 12 in a closed position retains the cartridge in electrical contact with the electrical connectors 19 so that a good electrical connection is maintained in use, whatever the orientation of the system is.

FIG. 2 is an exploded view of the cartridge 20. The cartridge housing 24 has a size and shape selected to be received into the cavity 18. The housing contains capillary material 27, 28 that is soaked in a liquid aerosol-forming substrate. In this example the aerosol-forming substrate comprises 39% by weight glycerine, 39% by weight propylene glycol, 20% by weight water and flavourings, and 2% by weight nicotine. A capillary material is a material that actively conveys liquid from one end to another, based on relative differences in liquid concentration. The capillary material may be made from any suitable material. In this example the capillary material is formed from polyester.

The cartridge housing 24 has an open end to which a heating element 30 is fixed. The heating element 30 comprises a substrate 34 having an aperture 35 formed in it, a pair of electrical contacts 32 fixed to the substrate and separated from each other by a gap 33, and a plurality of electrically conductive heater filaments 36 spanning the aperture and fixed to the electrical contacts on opposite sides of the aperture 35.

The heating element 30 is covered by a releasable seal 26. The releasable seal 26 comprises a liquid impermeable plastic sheet that is glued to the heating element 30 but which can be easily peeled off. A tab is provided on the side of the releasable seal 26 to allow a user to grasp the releasable seal 26 when peeling it off. It will be apparent to one of ordinary skill in the art that although gluing is described as the method to secure the impermeable plastic sheet to the heating element, other methods familiar to those in the art may also be used including heat sealing or ultrasonic welding, so long as the cover may easily be removed by a consumer.

There are two separate capillary materials 27, 28 in the cartridge of FIG. 2. A disc of a first capillary material 27 is provided to contact the heating element 36, 32 in use. A larger body of a second capillary material 28 is provided on an opposite side of the first capillary material 27 to the heating element. Both the first capillary material and the second capillary material retain liquid aerosol-forming substrate. The first capillary material 27, which contacts the heating element, has a higher thermal decomposition temperature (at least 160° C. or higher such as approximately 250° C.) than the second capillary material 28.

The capillary material 27, 28 is advantageously oriented in the housing 24 to convey liquid to the heating element 30. When the cartridge is assembled, the heater filaments 36 may be in contact with the capillary material 27 and so aerosol-forming substrate can be conveyed directly to the mesh heater. FIG. 3 is a detailed view of the filaments 36 of the heating element 30, showing a meniscus 40 of liquid aerosol-forming substrate between the heater filaments 36. It can be seen that aerosol-forming substrate contacts most of the surface of each filament 36 so that most of the heat generated by the heating element 30 passes directly into the aerosol-forming substrate.

So, in normal operation, liquid aerosol-forming substrate contacts a large portion of the surface of the heater filaments 36. However, when most of the liquid substrate in the cartridge has been used, less liquid aerosol-forming substrate will be delivered to the heater filaments 36. With less liquid to vaporize, less energy is taken up by the enthalpy of vaporization and more of the energy supplied to the heater filaments 36 is directed to raising the temperature of the heater filaments. Likewise, the energy required for maintaining a target temperature also decreases as the heater filaments 36 dry out. The heater filaments 36 may dry out because the aerosol-forming substrate in the cartridge has been depleted. Alternatively but less likely, the heater filaments 36 may dry out because the user is taking exceptionally long or frequent puffs and the liquid cannot be delivered to the heater filaments 36 as fast as it is being vaporized.

In use, the heating element 30 operates by resistive heating. Current is passed through the filaments 36 under the control of control electronics 16, to heat the filaments to within a desired temperature range. The mesh or array of filaments has a significantly higher electrical resistance than the electrical contacts 32 and electrical connectors so that the high temperatures are localised to the filaments. This minimises heat loss to other parts of the aerosol-generating device 10. In this example, the system is configured to generate heat by providing electrical current to the heating element 30 in response to a user puff.

The system includes a puff sensor configured to detect when a user is drawing air through the mouthpiece portion. The puff sensor (not illustrated) is connected to the control electronics 16 and the control electronics 16 are configured to supply current to the heating element 30 only when it is determined that the user is puffing on the device. Any suitable air flow sensor may be used as a puff sensor, such as a microphone or pressure sensor.

In order to detect an increase temperature of the heater filaments, the electric circuitry 16 is configured to measure the electrical resistance of the heater filaments. The heater filaments in this example are formed from stainless steel, and so have a positive temperature coefficient of resistance. In addition, because heat is generated in short bursts using high current pulses in such puff actuated system, stainless steel filaments having a relatively high specific heat capacity is ideal. As the temperature of the heater filaments 36 rises so does their electrical resistance.

The plots in FIG. 4a to 4c exemplarily illustrate the change in resistance of various heating elements during two consecutive heating cycles, each corresponding to a user puff. The plots of FIG. 4a relate to 2 consecutive heating cycles of a mesh heating element. The plots of FIG. 4b relate to a ceramic heating element. The plots of FIG. 4c relate to a wick & coil heating element.

In each of FIGS. 4a to 4c the left plot shows the increase in resistance when the heating element is in a wet state, in which sufficient liquid substrate is available for vaporization. In each of FIGS. 4a to 4c the right plot shows the increase in resistance when the heating element is in a dry state, in which not sufficient liquid substrate is available for vaporization.

Each of the heating cycles consists of 14 electric pulses. For each electric pulse the dot indicates the maximum resistance measured during the pulse. The x-axis represents the time scale and the y-axis represents the measured electrical resistance at the heating element 30.

The heating element 30 has an initial resistance Rini. Said initial resistance Rini is an intrinsic property of the heating element 30. It indicates a reference resistance of the heating element 30 at room temperature.

As power is applied to the heating element 30 during a user puff, the temperature of the heater filaments 36 rises from the ambient temperature. This causes the electrical resistance R of the heater filaments 36 to rise.

The resistance of the heater filaments 36 is related to the heater temperature in the temperature range of interest according to equation (1). Therefore by actively measuring the electrical resistance, the electric circuitry is able to determine the heater temperature at the heating element 30.

As can be seen in the plots of FIG. 4a, showing the increase of resistance at a mesh heating element, the resistance increases particularly at the start of the heating cycle. Thus, the increase of the electric resistance ratio between the first two heating pulses ΔR/Δt_{P2-P1} in each heating cycle is used as the monitored parameter in equation (2).

A rolling average s₁₀ of the previous 10 measurements for this electric resistance ratio ΔR/Δt_{P2-P1} and a standard deviation σ, in the form of a rolling average of the previous 30 measurements for this electric resistance ratio, is determined. These parameters are inserted in equation (2) leading to the following equation:

$$\\ \begin{matrix}\frac{Δ R}{Δ {t}_{P 2 - P 1}} - {s}_{10} > A σ , & ( 3 )\end{matrix}$$

wherein A is a constant parameter of 2.5. When the electric resistance ratio ΔR/Δt_{P2-P1} increases with respect to the average value s₁₀ by more than the product of the standard deviation σ and the constant parameter A, a dry wick state of the mesh heating element is detected.

The plots of FIG. 4b show the increase of resistance at a ceramic heating element. In this case the resistance does also increase, but the increase is particularly pronounced at the end of the heating cycle. The increase of the electric resistance ratio is determined from the maximum temperature measured throughout a complete heating cycle ΔR/Δt_{MAX}, which is used as the monitored parameter in equation (2).

A rolling average of the previous 10 measurements s₁₀ for this electric resistance ratio ΔR/Δt_{MAX} and a standard deviation, in the form of a rolling average a of the previous 30 measurements for this electric resistance ratio, is determined. These parameters are inserted in equation (2) leading to the following equation:

$$\\ \begin{matrix}\frac{Δ R}{Δ {t}_{MAX}} - {s}_{10} > A σ , & ( 4 )\end{matrix}$$

wherein A is a constant parameter of 1.25. When the electric resistance ratio ΔR/Δt_{MAX} increases with respect to the average value s₁₀ by more than the product of the standard deviation σ and the constant parameter A, a dry wick state of the ceramic heating element is detected.

The plots of FIG. 4c show the increase of resistance at a wick & coil heating element. In this case the increase of the electric resistance ratio ΔR/Δt_{RANGE} is determined from the increase in the temperature range of the heating element during a full heating cycle, wherein the temperature range is the difference between the maximum and the minimum temperatures during a heating cycle. Using the parameter ΔR/Δt_{RANGE} as the monitored parameter in equation (2) leads to the following equation:

$$\\ \begin{matrix}\frac{Δ R}{Δ {t}_{RANGE}} - {s}_{10} > A σ , & ( 5 )\end{matrix}$$

wherein A is a constant parameter of 1 or 1.5. When the electric resistance ratio ΔR/Δt_{RANGE} increases with respect to the average value s₁₀ by more than the product of the standard deviation σ and the constant parameter A, a dry wick state of the wick & coil heating element is detected.

FIG. 5 shows experimental data in which the resistance R is indicated for the lifecycle of a mesh heating element. In an initial phase 50 of the experiment, the heating element is flooded, which causes spitting (bubbles bursting due to rapid liquid heating). Accordingly, the shape of the resistance curves fluctuates slightly at the beginning of the test, until it reaches a stable and reproducible form. This main phase of optimal operation is referred to as “wet state” 52. In the wet state 52 the heating element is in a good condition and the final resistance of each puff remains constant. At an end phase 54 of the test instantaneous increase in resistance is detected. This increase corresponds to the heating element entering into a dry state 56. In a final phase 58, which is also referred to as runaway stage, the heater resistance increases exponentially and the heating element starts to glow. Heater temperature will rise to a maximum temperature in excess of 1200 degrees Celsius before burning out completely.

FIG. 6 shows similar experimental data as FIG. 5. Again a mesh heating element was tested. The experimental curves shown in FIG. 6 are reproduced with higher resolution. The three main phases, the initial phase 50 with bursting bubbles, the main phase in which the heating element is in a wet state 52 and the sudden increase in resistance indicating that the heating element is entering the dry state 56 can be seen.

FIG. 7 again shows experimental data for a mesh heating element. In this diagram also the results for the electrical resistance ratio ΔR/Δt_{P2-P1} as determined from equation (5) are indicated by curve 60. At the initial phase 50 the electric resistance ratio fluctuates somewhat leading to partly increased values. The increase is small enough such that the dry trigger is correctly not satisfied. During the wet state 52 the electrical resistance ratio remains rather constant and increases only upon entry of the heating element into the dry state 56. The red line 62 in FIG. 7 represents the logic output from the dry wick detection method of the present invention. This logic output is “0” at the initial phase 50 and during the wet state 52 and is increased to “1” when a dry state is detected. With the present invention the dry wick state 56 was detected at the correct puff. The enlarged view shows more details of the transition of the heating element between the wet state 52 and the dry state 56. The method was triggered by the puff immediately before the red line 62 during the first two heating pulses of this heating cycle. Accordingly, at this heating cycle the heating process would have been interrupted and the instant puff would not have been completed.

In FIG. 8 similar data for a ceramic heating element is depicted. Resistance of the ceramic heating element is very consistent in the wet state 52. Resistance increases in the dry state 56 for 2-3 puffs before decreasing rapidly as the metal elements of the ceramic heating element start to melt. For this heating element the electrical resistance ratio ΔR/Δt_{MAX} is used as indicated in equation (4). This electrical resistance ratio is also indicated in FIG. 8 with curve 60. Using this electrical resistance ratio as crucial parameter leads to detection of the dry state 56 as indicated by the red line 62 in FIG. 8. The method was triggered by the puff immediately to the left of the red line 62, which corresponds to the first puff in the dry state 56 of the heating element.

FIG. 9 shows experimental data for a wick & coil heating element. In this case, resistance increases by a large amount when the wick enters the dry state 56. Nevertheless, the resistance may not allow to reliably identify a dry state 56, because also in the wet state 52 an increase of resistance takes place. Therefore the electrical resistance ratio ΔR/Δt_{RANGE} taking into account the total change of resistance during a heating cycle is used as the decisive parameter according to equation (5). As can be seen in FIG. 9, during the wet state 52 the electrical resistance ratio ΔR/Δt_{RANGE} indicated by curve 60 largely remains constant as was observed in the case of the mesh heating element and the ceramic heating element. Again the method identifies a dry state 56 at the correct puff shown by the red line 62 in FIG. 9. The method was triggered by the puff immediately to the left of the red line 62, which corresponds to the first puff in the dry state 56 of the heating element.

FIG. 10 again shows experimental data for a mesh heating element. The curves marked with the blue frame, indicate the heating element being in the wet state 52. The curves marked with the red frame, indicate the heating element being in the dry state 56. In the enlarged view the angle θ is determined as a measure for the electrical resistance ratio ΔR/Δt. The angle θ is defined by two legs 64, 66. The first leg 64 may be approximated by a vertical line through the first point of each of the electrical resistance curves. The second leg 66 may be defined as a linear average of the electrical resistance readings at the later stage of the corresponding heating cycle.

As can be seen in FIG. 10, angle θ is constant throughout the wet state 52, but increases significantly upon entry into the dry state 56. Thus, also the angle θ may be used as the decisive parameter ΔR/Δt and may be inserted into equation (2) leading to the following equation:

$$\\ \begin{matrix}θ - {s}_{10} > A σ , & ( 6 )\end{matrix}$$

wherein A is a constant parameter of 2.5, and wherein s₁₀ and σ correspond to the rolling average and the standard deviation determined for angle θ. When the angle θ increases with respect to the average value s₁₀ by more than the product of the standard deviation σ and the constant parameter A, a dry wick state of the mesh heating element is detected.

The angle θ may be calculated from the slopes a₁ and a₂ of the two legs 64, 66 of the electrical resistance curve according to the following equation:

$$\\ \begin{matrix}θ = 180 - arc tan {a}_{1} + arc tan {a}_{2} , & ( 7 )\end{matrix}$$

wherein a₁ is the slope of the first leg 64 and a₂ is the slope of the second leg 66 of the electrical resistance curve.

A first method to determine the slopes of the two legs of the electrical resistance curve is illustrated in FIG. 11. In a first step the slopes L₁ and L₂ of the extreme ends of the electrical resistance curve are to be determined as illustrated in the left view of FIG. 10. To this end the first 10 data points of the first leg and the last 10 data points of the second leg are taken into account. Depending on the quality of the data a higher or a lower number of data points may be taken into account. In a next step the arithmetic average of these two slopes is determined leading to an average slope L=(L₁+L₂)/2.

In a third step illustrated in the middle view of FIG. 11 the data point (t_{L}, R_{L}) is identified at which the slope of the electrical resistance curve corresponds to the previously determined average slope L. This may be done by moving the function ΔR/Δt through the data set, for example by an algorithm using a fixed number of data points for the span ΔR and Δt.

This data point (t_{L}, R_{L}) is used to define the two straight lines approximating the two legs of the electrical resistance curve. The first straight line is the line through data points (t₁, R₁) and (t_{L}, R_{L}). The second straight line is the line through data points (t_{L}, R_{L}) and (t_{N}, R_{N}). This is shown in the right view of FIG. 10.

The slopes a₁ and a₂ are then calculated using the following formulas:

$$\\ \begin{matrix}{a}_{1} = ( {R}_{L} - {R}_{1} ) / ( {t}_{L} - {t}_{1} ) , & ( 8 )\end{matrix}$$

$$\\ \begin{matrix}{a}_{2} = ( {R}_{N} - {R}_{L} ) / ( {t}_{N} - {t}_{L} ) , & ( 9 )\end{matrix}$$

The values for the slopes a₁ and a₂ may be inserted into equation (7) in order to obtain the angle θ.

A further method to determine the two slopes makes use of the curvature k(t) of the electrical resistance curve. This method is illustrated in FIG. 12, in which the curvature of the electrical resistance curve is indicated.

The curvature k(t) may be calculated from the following equation:

$$\\ \begin{matrix}k ( t ) = \frac{{d}^{{}_{} 2} R / {dt}^{{}_{} 2}}{{[ 1 + {( dR / dt )}^{2} ]}^{3 / 2}} , & ( 10 )\end{matrix}$$

As can be seen from FIG. 12, the curvature k(t) exhibits an extremum point. This extremum point is the point where the curvature reaches a maximum value, and where the corresponding graph ‘bends’ the most. This point may be considered to define the transition point from the first leg of the electrical resistance curve to the second leg of the electrical resistance curve. This extremum point may again be used as data point (t_{L}, R_{L}), for the definition of the two straight lines approximating the two legs of the electrical resistance curve, as discussed in context with FIG. 11. The slopes a₁ and a₂ may then again be calculated using formulas (8) and (9) above.

As in the method described with FIG. 11, it may be preferable to use a certain predefined span ΔR and Δt for determination of the numeric derivatives. This may in particular be helpful if the data comprises increased electrical noise. The data set may also be smoothed by a filter function before the derivatives are determined.

The extremum point of the curvature can either be found by available system functions like ‘findmax( )’ or it can be calculated searching for the zero value of the first derivative of k(t). This zero value can be numerically determined using the Δk/Δt method.

The transition values (t_{L}, R_{L}) determined with these two methods do not necessarily have to be the same data points. However, the results show that in each case consistent results for detecting the electrical resistance ratio were obtained.

FIG. 13 shows a modification of the method of FIG. 12. In this method two separate points (t_{L1}, R_{L1}) and (t_{L2}, R_{L2}) are determined, which are then used for defining the straight lines a1 and a2 approximating the first and the second legs 64, 66 of the electrical resistance curve.

The two points (t_{L1}, R_{L1}) and (t_{L2}, R_{L2}) are defined by selecting a width w of the curvature extremum. In this case this width is defined by a percentage p of about 10% of curvature change from the curvature extremum.

It is considered that for correctly detecting a dry wick state, the point of time has to be determined at which the angle θ starts to increase significantly. It seems that this increase is mainly driven by the runaway in the second leg 66, and does not depend so much on the slope a1 of the first leg. Thus, as mentioned earlier, it seems to be well justified to approximate the slope a1 of the first leg to be infinite and to be represented by a vertical line.

Further, it may also not be necessary to take all data points of the second leg into account when determining the angle θ. In particular, if the runaway is fast and may cause destruction within a single heating cycle, the required data points may be restricted to the data points after but near the curvature extremum. In this way, it may be possible to determine within a single heating cycle whether a dry wick state is entered and to cut off power supply instantly. Thus, this method may again allow to detect a dry wick state at a very early state and does not require the system to wait until a given heating cycle is terminated.

As can be seen from the above, it is necessary to define a transition point for separating the data set into data points defining the first leg 64 and data points defining the second leg 66 of the electrical resistance curve. Which method is the most appropriate method may depend on the accuracy needed and the noisiness of the electrical resistance data.

FIG. 14 shows a flowchart illustrating the individual steps of the method of the present invention using a two-trigger system. Upon activation (step 70) the aerosol-generating device is flagged to “wet”, indicating that the device is ready for operation. Aerosol generation is initiated and the electrical resistance ratio ΔR/Δt is determined (step 72). Subsequently the system state is checked (step 74). Since the device is currently flagged as “wet”, the method will determine whether the electrical resistance ratio satisfies the “dry trigger” (step 76). If the dry trigger is not satisfied the aerosol-generating device is continued to be flagged as “wet” (step 78). The determined electrical resistance ratio is used to update the standard deviation—and a new rolling average s10 (step 80). The user may then continue the user experience by taking further puffs (step 82).

When the electrical resistance ratio ΔR/Δt increases significantly such that the “dry trigger” is satisfied the aerosol-generating device is flagged as “dry” (step 84). The system enters the “cool down period”, in which the system is temporarily locked (step 86). The cool down period lasts for 5 to 10 seconds. This temporary locking of the system is hardly perceived by the user, since this time period corresponds to the average break between two consecutive puffs.

When the “cool down period” has expired, the system is allowed to resume operation and the user may draw a further puff (step 70). For this puff again aerosol generation is initiated and the electrical resistance ratio ΔR/Δt is determined (step 72). Since the device has been flagged as “dry” at the end of the previous puff, the method will now determine whether the electrical resistance ratio satisfies the “lock-out trigger” (step 88). If the lock-out trigger is indeed satisfied, which means that detection of the dry state of the wick is confirmed, the aerosol-generating device is permanently set in the lock-out state (step 90). In such case, the system will cease operating and the user will be prompted to change or refill the cartridge.

If the lock-out trigger is not satisfied, this means that a dry state status of the wick is not confirmed. In this case, the aerosol-generating device is again flagged as “wet” (step 92). The determined electrical resistance ratio is used to update the standard deviation—and a new rolling average s10 (step 80). The user may then continue the user experience by taking further puffs.

The two triggers, the dry trigger and the lock-out trigger, can be adjusted by choosing different values for the constant parameter A. If the same value is used for both triggers, basically the same condition is applied twice in order to re-confirm a dry state of the heating element. In order to increase sensitivity, a lower parameter A may be chosen for the dry trigger. Such increased sensitivity may, however, produce an increased number of false positives. In order to compensate for these false positives, a higher value of parameter A may be used for the lock-out trigger. This may prevent the device from prematurely entering the permanent lock-out, i.e. from entering into a permanent lock-out although the wick is actually not yet in a dry state.

1.-14. (canceled)

15. A method of controlling a supply of power to a heating element in an electrically operated aerosol-generating system, the method comprising:
regulating the supply of power to the heating element during a plurality of discrete heating cycles;
determining an electrical resistance ratio ΔR/Δt of the heating element for a predefined time interval during a heating cycle;
calculating a rolling average value sₙ of the electrical resistance ratio ΔR/Δt of the heating element for n preceding heating cycles, wherein n is an integer greater than 1;
comparing the electrical resistance ratio ΔR/Δt of the heating element with the calculated rolling average value;
determining an adverse condition when the electrical resistance ratio ΔR/Δt is greater than the calculated rolling average value by more than a threshold value; and
controlling power supplied to the heating element based on whether an adverse condition at the heating element is determined,
wherein the threshold value for determining an adverse condition is determined from a standard deviation σ of the electrical resistance ratio ΔR/Δt.

16. The method according to claim 15, wherein electrical power is supplied to the heating element during each heating cycle in pulsed mode.

17. The method according to claim 15, wherein electrical power is supplied to the heating element in fixed power mode or in fixed duty cycle mode.

18. The method according to claim 15, wherein n for determining the rolling average sₙ of the electrical resistance ratio ΔR/Δt is between 5 and 30.

19. The method according to claim 15, wherein n for determining the rolling average sₙ of the electrical resistance ratio ΔR/Δt is 10.

20. The method according to claim 15, wherein the threshold value for determining an adverse condition is determined from the standard deviation σ of the electrical resistance ratio ΔR/Δt taking into account the rolling average of the resistance ratio ΔR/Δt determined in the previous 50 heating cycles, or the previous 30 heating cycles, or the previous 10 heating cycles.

21. The method according to claim 15, wherein the threshold value for determining an adverse condition is determined from the standard deviation σ of the electrical resistance ratio ΔR/Δt taking into account the rolling average of the resistance ratio ΔR/Δt determined in the previous 30 heating cycles.

22. The method according to claim 20, wherein the threshold value for determining an adverse condition is determined from a product of the standard deviation σ of the electrical resistance ratio ΔR/Δt and a predefined constant value.

23. The method according to claim 22, wherein the predefined constant value depends on a type of the heating element used in the aerosol-generating system.

24. The method according to claim 23, wherein the predefined constant value amounts to about 2.5 for a mesh heater, to 1.25 for a ceramic heater, and to about 1.5 for a wick and coil heater.

25. The method according to claim 15, wherein the aerosol-generating system is transferred into a locked state if an adverse condition is determined.

26. The method according to claim 15, wherein after a predefined time lapse in the locked state, the aerosol-generating system is unlocked such that operation of the heating element may be resumed.

27. The method according to claim 15, wherein the heating element is a mesh heater and the electrical resistance ratio ΔR/Δt is determined from a maximum resistance value determined in the first two heating pulses of a heating cycle.

28. The method according to claim 15, wherein the heating element is a ceramic heater and the electrical resistance ratio ΔR/Δt is determined from a difference in maximum resistance values determined in consecutive heating cycles.

29. The method according to claim 15, wherein the heating element is a wick and coil heating element and the electrical resistance ratio ΔR/Δt is determined from a difference in resistance determined in consecutive heating cycles.

30. An electrically operated aerosol-generating system, comprising:
a heating element configured to heat an aerosol-forming substrate proximate to the heating element;
a power supply configured to supply power to the heating element; and
electric circuitry configured to:
regulate a supply of power to the heating element during a plurality of discrete heating cycles,
determine an electrical resistance ratio ΔR/Δt of the heating element for a predefined time interval,
calculate a rolling average value sₙ of the electrical resistance ratio ΔR/Δt of the heating element for n preceding heating cycles, wherein n is an integer greater than 1,
compare the electrical resistance ratio ΔR/Δt of the heating element with the calculated rolling average value sₙ;
determine an adverse condition when the electrical resistance ratio ΔR/Δt is greater than the rolling average value sₙ by more than a threshold value, and
control power supplied to the heating element based on whether an adverse condition at the heating element is determined,
wherein the threshold value for determining an adverse condition is determined from the standard deviation σ of the electrical resistance ratio ΔR/Δt.
